(19) United States
(12) Patent Application Publication
(10) Pub. No.: US 2004/0169408 A1
(43) Pub. Date: Sep. 2, 2004

(54) Furniture drive for displacing components of a piece of furniture relative to one another

(76) Inventor: Eckhart Dewert, Zurich (CH)

Correspondence Address: ROBERT W. BECKER & ASSOCIATES, Suite B, 707 Highway 66 East, Tijeras, NM, 87059, US

(21) Appl. No.: 10/795,460

(22) Filed: Feb. 6, 2004

Related U.S. Application Data
(63) Continuation of application No. PCT/EP02/08694, filed on Aug. 5, 2002.

(30) Foreign Application Priority Data
Aug. 8, 2001 (DE) 101 38 025.9

(51) Int. Cl. B60N 2/02

(52) U.S. Cl. 297/285

(57) ABSTRACT

A furniture drive for displacing components of a piece of furniture is provided. An adjustment element is pivotably mounted on a main body and serves for displacing a component of a piece of furniture. A drive element is drivingly connected with the adjustment element for displacing the same. A lever gear mechanism is disposed between the drive element and the adjustment element for effecting the driving connection therebetween.

### RELATED APPLICATIONS

This application is a continuation of PCT/EP02/08694 filed Aug. 5, 2002, which claims priority to DE 101 38 025.9 filed Aug. 8, 2001.

### BACKGROUND OF THE INVENTION

The present invention relates to a furniture drive for displacing components of a piece of furniture relative to one another.

Furniture drives are known, for example, from EP 0 372 032 B1, DE 38 42 078 C2, and EP 0 583 660 B1, which serve for the displacement of components of lattice structures.

DE 100 17 978 A1 discloses a furniture drive of the aforementioned type that has a main body in the form of a housing to which is pivotably mounted an adjustment element for displacing a component of a piece of furniture. The known furniture drive is furthermore provided with a drive element that is in driving connection with the adjustment element for displacing the same.

It is an object of the present invention to provide a furniture drive of the aforementioned general type that is easy and economical to produce, that has a robust construction, and that is suitable for the application of great forces.

### BRIEF DESCRIPTION OF THE DRAWINGS

This object, and other objects and advantages of the present invention, will appear more clearly from the following specification in conjunction with the accompanying schematic drawings, in which:

FIG. 1 is a side view of one exemplary embodiment of an inventive support arrangement in the form of a lattice structure, whereby the support components of the arrangement are not displaced relative to one another;

FIG. 2 is a side view showing the support arrangement of FIG. 1, whereby the support components of the arrangement are displaced relative to one another;

FIG. 3 is a very schematic side view of a portion of one exemplary embodiment of an inventive furniture drive, embodied as a dual drive, in a first adjustment position, whereby half of the housing is omitted for the sake of illustration;

FIG. 4 is a side view, in a smaller scale, of the furniture drive of FIG. 3 in a second adjustment position;

FIG. 5 is a side view, in a smaller scale, of the furniture drive of FIG. 3 in a third adjustment position; and

FIG. 6 shows in a smaller scale the furniture drive of FIG. 3, whereby for the sake of illustration half of the housing is omitted, and both drive units of the dual drive are illustrated.

### SUMMARY OF THE INVENTION

Pursuant to the present application, a lever gear mechanism is disposed in the drive train between the drive element and the adjustment element. By the use of a lever gear mechanism, the inventive furniture drive is easy and economical to produce, has a robust construction, and is suitable for the application of great forces.

Pursuant to a very advantageous development of the inventive furniture drive, the drive element, or an intermediate component that is connected therewith, loosely acts upon a lever of the lever gear mechanism. In this embodiment, the displacement of the adjustment element out of a starting position and into a displacement position is effected in that the drive element or the intermediate component acts upon a lever of the lever gear mechanism with a displacement force. A return of the adjustment element out of the adjustment position back into the starting position is effected under the weight of a component of a piece of furniture displaced with the adjustment element, for example a support component of a lattice structure. Since the lever of the lever gear mechanism is loosely acted upon by the drive element or by the intermediate component, the adjustment element, together with the lever gear mechanism, is freely movable from the starting position into the adjustment position when the drive is not activated, thereby simplifying, for example, the installation of the drive into a piece of furniture, for example a lattice structure.

Pursuant to one advantageous further development of the inventive furniture drive, the intermediate component is a slide that is functionally connected with a lever of the lever gear mechanism that is acted upon with pressure during the displacement of the adjustment element. This embodiment is particularly easy and economical to produce. With this embodiment, the slide can have any desired configuration, and can, for example, be formed by a spindle nut or a component that is connected with an adjusting spindle.

Pursuant to another very advantageous further development of the inventive furniture drive, the lever gear mechanism engages the adjustment element at at least two locations that are spaced from one another in the circumferential direction of the pivot axis of the adjustment element. In this way, relative to the pivot axis of the adjustment element, a uniform introduction, in the circumferential direction of the force exerted by the lever gear mechanism into the adjustment element, is achieved. Stressing and twisting of the adjustment element are thereby reliably avoided.

A particularly uniform introduction of force results if the lever gear mechanism engages the adjustment element at at least two locations that are diametrically opposite one another relative to the pivot axis.

The construction of the lever gear mechanism can be selected over a wide range in conformity with requirements, whereby, for example, single-arm levers, dual-arm levers, angle levers, or some other type of lever could be utilized. Furthermore, the number of levers and there length ratios can vary over a wide range in order to establish a desired reduction ratio.

Pursuant to the structurally most straightforward embodiment, and hence the most economical to produce, the lever gear mechanism has a first lever, one end of which is linked to the adjustment element, and which is in a force-transfer connection with the drive element.

Pursuant to a further development of the inventive furniture drive, the lever gear mechanism has a second lever that is linked to the adjustment element, whereby to displace the adjustment element one of the levers pulls the adjustment element and the other lever presses against the adjustment element. This embodiment is straightforward and hence economical to produce.

Pursuant to one expedient further development of the inventive furniture drive, the first lever and the second lever are coupled to one another by coupling means. Such coupling means ensure that the two levers carry out the movements necessary for the displacement of the adjustment element in a coordinated manner.

The coupling means can have any suitable configuration. Pursuant to one particularly straightforward and hence economical to produce further development of the inventive furniture drive, the coupling means have a third lever.

With the aforementioned embodiment, the third lever is expediently a dual-arm lever, one lever arm of which is linked to the first lever and the other lever arm of which is linked to the second lever. This embodiment has a particularly straightforward construction, and is hence particularly economical to produce. Furthermore, such an embodiment is particularly robust.

The drive element of the inventive furniture drive is expediently a linearly movable drive element.

Pursuant to a further development of the aforementioned embodiment, the linearly movable drive element is a torsionally resistant spindle nut that is movable in the axial direction and is held upon a rotationally drivable adjusting spindle. Such spindle drives are available as simple and economical standard components and are suitable for the application of great forces.

In a kinematic reversal of the aforementioned embodiment, the linearly movable drive element can, however, also be an adjusting spindle that is movable in the axial direction and is guided in a torsionally resistant manner, with a rotationally drivable spindle not being disposed on the adjusting spindle.

Pursuant to another very advantageous further development of the inventive furniture drive, the adjustment element can be fixedly connectable with a rotatably mounted shaft that in the assembled position of the furniture drive is in functional connection with a component of the piece of furniture for displacing the same. This embodiment has a simple construction and is particularly robust, so that with this embodiment of the inventive furniture drive particularly great forces can be applied. Furthermore, the assembly of the furniture drive on a piece of furniture is simplified.

Pursuant to a further development of the aforementioned embodiment, the adjustment element can be connected with the shaft in a positive or form-locking manner to form a connection that is fixed against rotation. This embodiment is also particularly robust and is particularly suitable for the transfer of great forces.

Pursuant to another further development, the shaft has a non-round cross section and in the assembled position of the furniture drive engages in a positive manner in a recess of the adjustment element, which recess has a shape that is essentially complementary to the cross section of the shaft. This embodiment has a particularly straightforward construction and is hence particularly economical to produce. Furthermore, it is very robust and facilitates the assembly or mounting of the furniture drive on a piece of furniture.

Pursuant to a further development of the aforementioned embodiment, the recess of the pivot lever is open in the radial direction of the shaft. This facilitates the introduction of the shaft into the recess during the assembly of the inventive furniture drive.

With the aforementioned embodiment, if necessary arresting means can be provided for securing the shaft in the recess. Such arresting means prevent the shaft from coming out of the recess during a displacement movement.

A support arrangement that is adapted to be adjusted via a motor and that serves for supporting upholstery, cushioning or padding of a piece of furniture for sitting and/or lying on, for example a mattress of a bed, is also provided. Such a support arrangement is provided with at least one furniture drive of the type previously discussed. Such a support arrangement can be embodied as a lattice structure.

Further specific features of the present invention will be described in detail subsequently.

### DESCRIPTION OF PREFERRED EMBODIMENTS

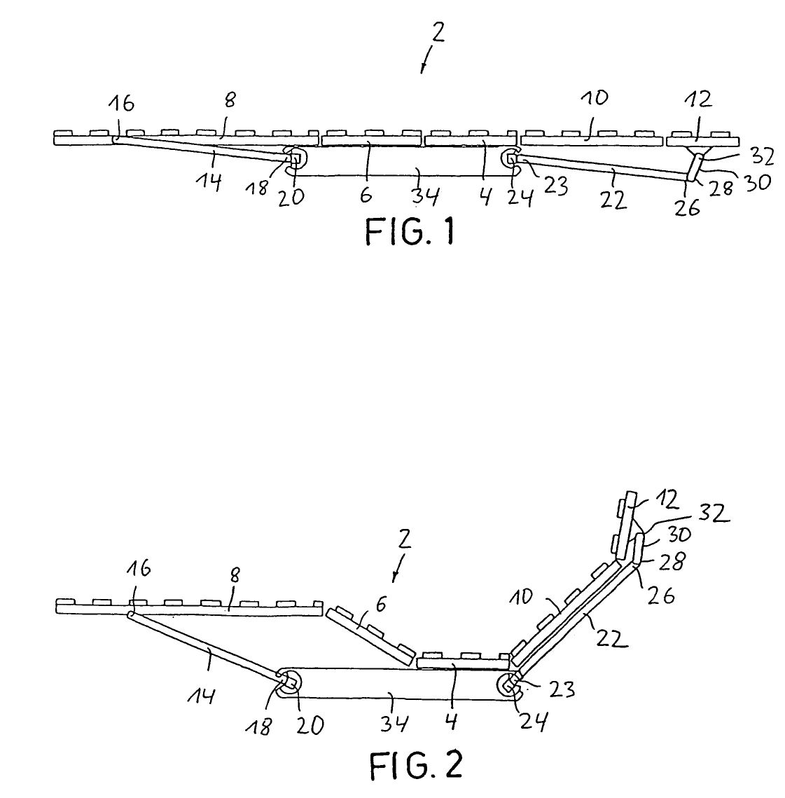

Referring now to the drawings in detail, FIG. 1 illustrates one exemplary embodiment of an inventive support arrangement 2 in the form of a lattice structure for supporting upholstery, cushioning or padding, which is not illustrated in the drawing, of a piece of furniture for sitting and/or lying on, for example a mattress of a bed. The support arrangement 2 is provided with a plurality of support components, which are pivotable relative to one another about horizontal pivot axes that are disposed parallel to one another, and serves for the support of the non-illustrated upholstery, cushioning or padding of the furniture for sitting and/or lying on.

In detail, the support arrangement 2 has a central support component 4, which is pivotably connected at one side with a leg support component 6 and is pivotable about a horizontal pivot axis; at its end that is remote from the central support component 4, the leg support component 6 is pivotably connected with a calf support component 8 and is pivotable about a horizontal pivot axis.

On that side that is remote from the leg support component 6, the central support component 4 is pivotably connected with an upper body support component 10 and is pivotable about a horizontal pivot axis; on that side remote from the central support component 4, the upper body support component 10 is pivotably connected with a head support component 12 and is pivotable about a horizontal pivot axis.

In order to pivot the leg support component 6 and the calf support component 8 relative to the central support component 4, an adjustment lever 14 is provided, the one end 16 of which is linked to the calf support component 8, and the other end 18 of which is fixedly connected with a shaft 20, in the form of a square shaft, that is mounted, so as to be rotatable about a horizontal axis of rotation, on a frame of the support arrangement 2 that is not illustrated in the drawing.

In order to pivot the upper body support component 10 and the head support component 12 relative to the central support component 4, a further adjustment lever 22 is provided, the one end 23 of which is fixedly connected with a shaft 24, in the form of a square shaft, that is mounted, so as to be rotatable about a horizontal axis of rotation, on the non-illustrated frame of the support arrangement 2; the other end 26 of the adjustment lever 22 is connected with an end 28 of a further adjustment lever 30, that end 32 of which that is remote from the adjustment lever 22 being pivotably connected with the head support component 12.

FIG. 2 shows the support arrangement 2 of FIG. 1 in a position in which the support components 6, 8 and 10, 12 are pivoted relative to the central support component 4.

Pursuant to the invention, to pivot the support components 6,8 and 10, 12 relative to the central support component 4, furniture drives are provided that are accommodated in a common housing 34 below the support arrangement 2. In the embodiment of FIG. 1, the furniture drives disposed in the housing 34 are carried by the shafts 20, 24, which in turn are rotatably mounted on the non-illustrated frame of the support arrangement 2. However, the housing 34 can also be secured, for example, on the non-illustrated frame of the support arrangement 2.

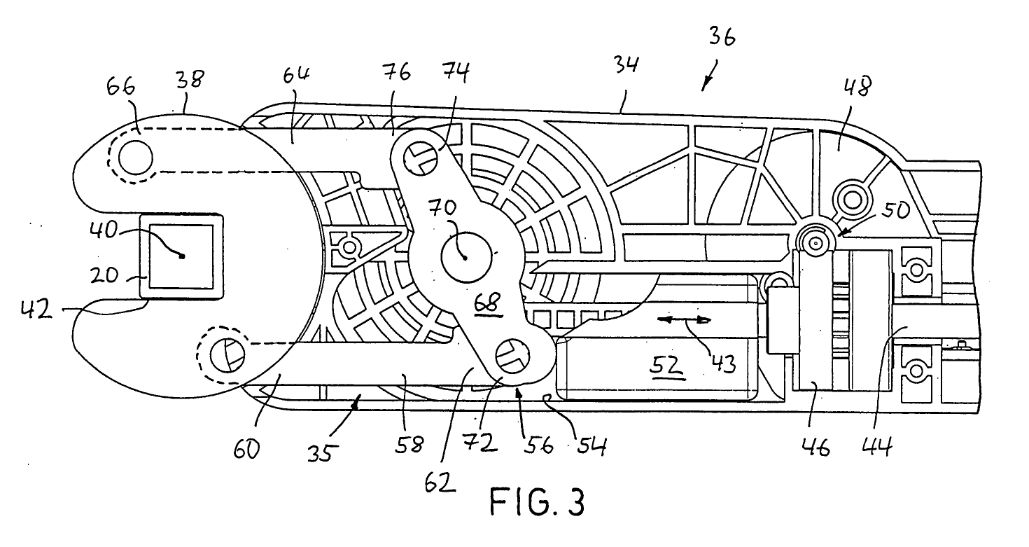

FIG. 3, in a very schematic manner, shows a partial view of one exemplary embodiment of an inventive furniture drive 36 for displacing components of a piece of furniture relative to one another, wherein the main body of this embodiment is formed by the housing 34. The furniture drive 36 has two drive units 35, 35′, which are accommodated in the housing 34; in FIG. 3, merely the drive unit 35 is shown. The drive unit 35 is provided with an adjustment element 38, which is embodied as a shaft-receiving means and is mounted on the housing 34 so as to be pivotable about a pivot axis 40. To form a fixed connection, the adjustment element 38 is connected with the shaft 20 in a positive or form-locking manner (see, for example, FIG. 1). For this purpose, the shaft 20 has a non-round cross section in the form of a square, and engages in a positive manner in a recess 42 of the adjustment element 38, with such recess having a shape that is essentially complementary to that of the shaft 20, and which in the radial direction of the shaft 20 has an open side. In the assembled position of the furniture drive 36, the shaft 20 is held in the recess 42 in a frictionally engaging manner.

The drive unit 35 is furthermore provided with a drive element that is movable back and forth in the direction of the double arrow 43, and that in this embodiment is formed by an adjusting spindle 44 that is movable in the axial direction, is guided in a torsion-resistant manner, and in which is disposed a rotatably driveable spindle nut 46. Provided as a rotational drive for the spindle nut 46 is an electric motor 48, which is in rotational drive connection with the spindle nut 46 via a gear mechanism 50. Connected with the adjusting spindle 44 in a shift- and torsion-resistant manner is a slide 52, which is guided along an inner wall 54 of the housing 34.

Pursuant to the invention, disposed in the drive train, between the adjusting spindle 44 and the adjustment element 38, is a lever gear mechanism 56 having a first lever 58, the one end 60 of which is linked to the adjustment element 38 eccentrically to the pivot axis 40, and the other end 62 of which rests against that surface of the slide 52 that is remote from the spindle nut 46, and is loosely acted upon by the slide. In this embodiment, the lever gear mechanism 56 is furthermore provided with a second lever 64, the one end 66 of which is linked to the adjustment element 38 eccentrically to the pivot axis 40. As can be seen from FIG. 3, in this embodiment the ends 60, 66 of the levers 58, 64 are linked to the adjustment element 38 at locations that are diametrically opposite relative to the pivot axis 40.

The lever gear mechanism 56 is furthermore provided with a third lever 68, which in this embodiment is embodied as a dual-arm lever, and is mounted on an inner wall of the housing 34 so as to be pivotable about a pivot axis 70 that is parallel to the pivot axis 40 of the adjustment element 38. A lever arm 72 of the third lever 68 is linked to that end 62 of the first lever 58 that is remote from the adjustment element 38, while its other lever arm 74 is linked to that end 76 of the second lever 64 that is remote from the adjustment element 38. The third lever 68 forms coupling means for transmitting movement of the first lever 58 to the second lever 64, so that movements of the levers 58, 64 are coupled to one another, whereby the levers 58, 64 move in opposite directions. As can be seen from the drawing, the first lever 58 and the second lever 64 have the same length. Furthermore, the ends of the levers 58, 64 are linked to the third lever 68 at equal distances relative to the pivot axis 70 of the third lever.

Although not visible from the drawing, the third lever 68 is comprised of two flat lever portions that are spaced from one another in the axial direction of the pivot axis 70, so that the lever arms 72, 74 of the third lever 68 are embodied as forks, between which the levers 58 and 64 are received.

The function of the inventive furniture drive 36 is as follows:

In the assembled position of the furniture drive 36, the shaft 40 is positively received in the recess 42 of the adjustment element 38, as can be seen from FIG. 3. To pivot the shaft 20 out of the starting position, illustrated in FIGS. 1 and 3, and into a displaced position illustrated in FIG. 2, the electric motor 48 drives the spindle nut 46 in such a way that the adjusting spindle 44 is moved toward the left together with the slide 52 in FIG. 3, so that the first lever 58 is also moved toward the left and in so doing pivots the third lever 68 in a clockwise direction, so that at the same time the second lever 64 is moved toward the right. In so doing, the first lever 58 pushes against the adjustment element 38 while the second lever 64 pulls on the adjustment lever 38, so that the adjustment lever is pivoted in a clockwise direction. As a consequence, the shaft 20 is also pivoted in a clockwise direction, so that the leg support component 6 together with the calf support component 8 are pivoted into the displacement position illustrated in FIG. 2.

A return from the adjustment position illustrated in FIG. 2 to the starting position illustrated in FIG. 1 is effected under the weight of the leg support component 6 and of the calf support component 8 and of a person that is possibly resting upon the support arrangement, whereby the furniture drive 36 is activated.

Due to the fact that the lever gear mechanism 56 engages at locations on the adjustment element 38 that are spaced from one another in the circumferential direction of the pivot axis 40 and are diametrically opposed from one another relative to the pivot axis 40, a uniform introduction of force into the adjustment element 38 is ensured. Stressing or twisting of the adjustment element 38 due to non-uniform introduction of force is thus reliably avoided. Furthermore, since the slide 52 loosely acts upon the first lever 58 of the lever gear mechanism 56, assembly of the furniture drive 36 on the support arrangement 2 is simplified, since the adjustment element 38 can be freely rotated between the starting position and the displacement position if the slide 52 is in its starting position illustrated in FIG. 3.

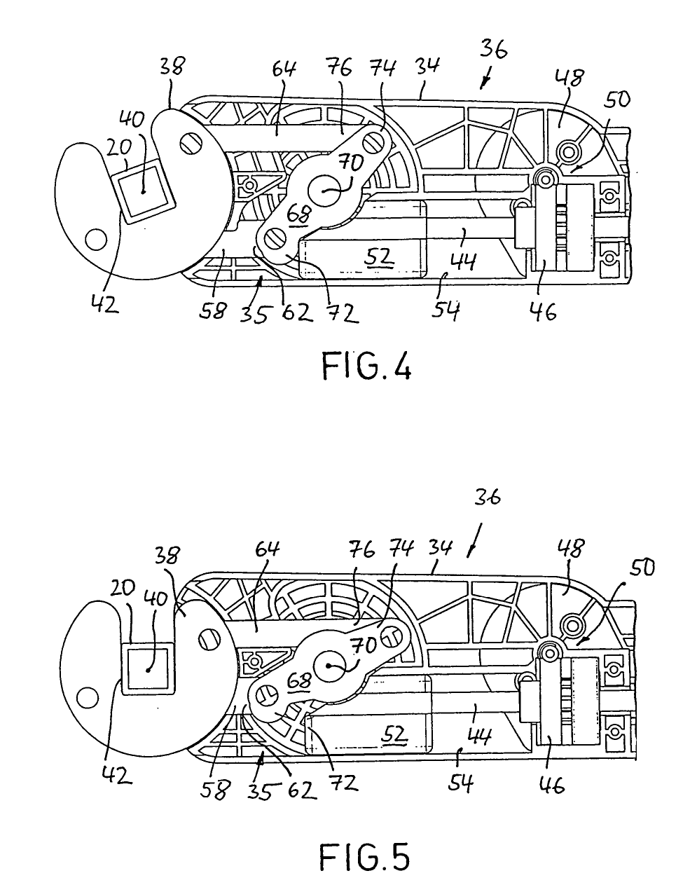

In FIGS. 4 and 5 the drive unit 35, which is illustrated in FIG. 3 in a first end position of the displacement movement, is illustrated in further displacement positions, whereby the displacement position illustrated in FIG. 5 is a second end position of the adjustment movement. By comparing FIGS. 3 and 5 it can be seen that the shaft 20 is pivotable by 90° via the drive unit 35. However, with an appropriate construction of the adjustment element 38 and of the lever gear mechanism 56, it would also be possible to achieve maximum pivot angles of either less than 90° or more than 90°.

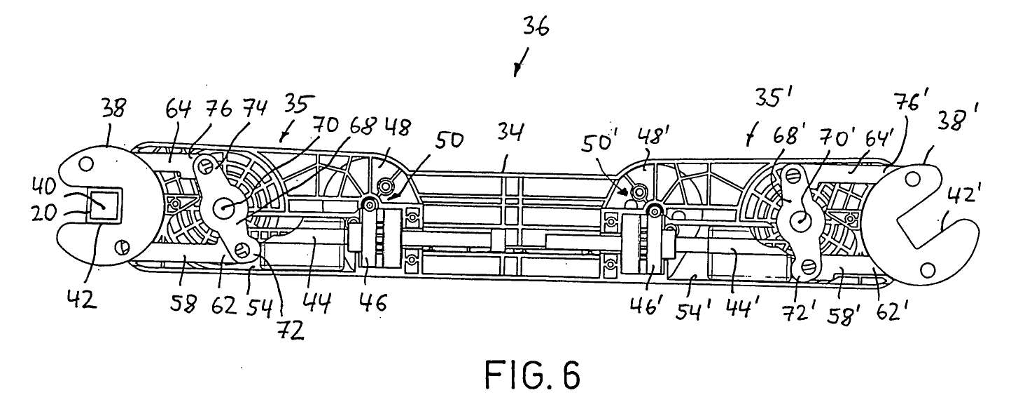

From FIG. 6 it can be seen that in addition to the drive unit 35, a further drive unit 35′ could also be accommodated in the housing 34 so that the inventive furniture drive 36 is in this embodiment embodied as a dual drive. However, the inventive furniture drive can in principle also be constructed as a single drive. The drive unit 35′ is constructed in a manner corresponding to the construction of the drive unit 35; the components of the drive unit 35′ are provided with reference numerals that correspond to the reference numerals of the component of the drive unit 35, with the addition of a prime.

The specification incorporates by reference the disclosure of German priority document 101 38 025.9 filed Aug. 8, 2001 and PCT/EP02/08694 filed Aug. 5, 2002.

The present invention is, of course, in no way restricted to the specific disclosure of the specification and drawings, but also encompasses any modifications within the scope of the appended claims.

1. A furniture drive for displacing components of a piece of furniture relative to one another, comprising:
a main body;
an adjustment element pivotably mounted on said main body and serving for displacing a component of the piece of furniture;
a drive element that is drivingly connected with said adjustment element for displacing the latter; and
a lever gear mechanism disposed between said drive element and said adjustment element for effecting said driving connection therebetween.

2. A furniture drive according to claim 1, wherein said lever gear mechanism has a lever and wherein said drive element, or an intermediate component that is connected with said drive element, acts loosely upon said lever of said lever gear mechanism.

3. A furniture drive according to claim 2, wherein said intermediate component is a slide that is in functional connection with said lever of said lever gear mechanism, and wherein said lever is acted upon with pressure during a displacement of said adjustment element.

4. A furniture drive according to claim 1, wherein said lever gear mechanism engages said adjustment element at at least two locations that are spaced from one another in a circumferential direction of a pivot axis of said adjustment element.

5. A furniture drive according to claim 4, wherein said lever gear mechanism engages said adjustment element at at least two locations that are disposed diametrically opposite one another relative to said pivot axis.

6. A furniture drive according to claim 1, wherein said lever gear mechanism is provided with a first lever, one end of which is linked to said adjustment element, and wherein said first lever is in force transferring connection with said drive element.

7. A furniture drive according to claim 6, wherein said lever gear mechanism is provided with a second lever that is linked to said adjustment element, and wherein for a displacement of said adjustment element one of said levers acts in a pulling manner upon said adjustment element and the other of said levers acts in a pushing manner upon said adjustment element.

8. A furniture drive according to claim 7, wherein said first and second levers are coupled to one another via a coupling means.

9. A furniture drive according to claim 8, wherein said coupling means is provided with a third lever.

10. A furniture drive according to claim 9, wherein said third lever is a dual-arm lever including a first lever arm that is linked to said first lever and a second lever arm that is linked to said second lever.

11. A furniture drive according to claim 1, wherein said drive element is a linearly movable drive element.

12. A furniture drive according to claim 11, wherein said linearly movable drive element is a torsionally resistant spindle nut that is movable in an axial direction, and wherein said spindle nut is held on a rotationally drivable adjusting spindle.

13. A furniture drive according to claim 11, wherein said linearly movable drive element is an axially movable adjusting spindle that is guided in a torsionally resistant manner, and wherein said adjusting spindle is disposed on a rotationally driveable spindle nut.

14. A furniture drive according to claim 1, wherein said adjustment element is adapted to be connectable with a rotatably mounted shaft so as to be fixed against rotation relative thereto, and wherein, in an assembled state of said furniture drive, said shaft is in functional connection with a component of the piece of furniture for a displacement of said component.

15. A furniture drive according to claim 14, wherein to form said fixed connection said adjustment element is adapted to be connected with said shaft in a positive or form-locking manner.

16. A furniture drive according to claim 15, wherein said adjustment element has a recess having a cross-sectional shape that is essentially complementary to a cross-section of said shaft, wherein said shaft has a non-round cross section, and wherein in an installed state of said furniture drive said shaft positively engages in said recess of said adjustment element.

17. A furniture drive according to claim 16, wherein said recess of said adjustment element is open in a radial direction of said shaft.

18. A furniture drive according to claim 17, wherein an arresting means is provided for securing said shaft in said recess.

19. A support arrangement that is adapted to be adjusted via a motor and serves for supporting upholstery, cushioning or padding, comprising:
a first support component;
at least one second support component, said support components serving for a flat support of said upholstery, cushioning or padding, wherein said first and second support components are pivotably interconnected; and
a drive unit for pivoting said first and second support components relative to one another, wherein said drive unit is provided with at least one furniture drive according to claim 1.

20. A support arrangement according to claim 19, wherein said support arrangement is embodied as a lattice structure.

21. A piece of furniture for sitting and/or lying upon and being provided with a support arrangement according to claim.
